(19) United States
(12) Patent Application Publication
(10) Pub. No.: US 2008/0316120 A1
(43) Pub. Date: Dec. 25, 2008

(54) ELECTRONIC APPARATUS

(75) Inventors: Toshiyuki Hirota, Hino-shi (JP); Hironori Motoe, Ome-shi (JP); Noriyasu Kawamura, Kokubunji-shi (JP); Tomomi Murayama, Nishitama-gun (JP); Kentaro Tomioka, Sayama-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/140,876

(22) Filed: Jun. 17, 2008

(30) Foreign Application Priority Data
Jun. 19, 2007 (JP) 2007-161468

(51) Int. Cl. H01Q 1/24

(52) U.S. Cl. 343/702

(57) ABSTRACT

According to one embodiment, an electronic apparatus includes a housing, an inner conductor member provided inside the housing, a conductor part with which the housing is provided, and which restrains undesired electromagnetic radiation from leaking from inside the housing to the outside, and an antenna including an antenna element that is provided on an outer surface of the housing, the antenna using the conductor part as an antenna ground. The housing includes a non-conductor part that is out of the conductor part at least at a part of a region in which the antenna element is provided. When the antenna is viewed from a direction in which the antenna element and the housing overlap each other, a size of a part of the antenna element overlapping the non-conductor part is larger than a part of the antenna element overlapping the conductor part.

### CROSS-REFERENCE TO RELATED APPLICATIONS

This application is based upon and claims the benefit of priority from Japanese Patent Application No. 2007-161468, filed Jun. 19, 2007, the entire contents of which are incorporated herein by reference.

### BACKGROUND

1. Field

One embodiment of the invention relates to an electronic apparatus provided with an antenna.

2. Description of the Related Art

With the size reduction of electronic apparatuses in recent years, an electronic apparatus in which an antenna is mounted on an outer surface of a housing is provided. Jpn. Pat. Appln. KOKAI Publication No. 11-127010 discloses a wireless electronic apparatus in which an antenna conductor plate is provided on an outer surface of a housing, and a grounding conductor plate corresponding to the antenna conductor plate is provided inside the housing.

The grounding conductor plate of this wireless electronic apparatus is formed by sticking a thin metallic plate on an inner surface of a housing or plating the inner surface of the housing with metal. This allows the grounding conductor plate to function as a grounding plate corresponding to the antenna conductor plate, and function as a shielding member for preventing an undesired radio wave from affecting a circuit board contained in the housing.

Incidentally, the grounding conductor plate described in the above patent document is provided on almost the entire inner surface of the housing. The present inventors have found that with such an antenna mounting structure, an antenna is limited in its type.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention;

FIG. 2 is an exemplary perspective view of the portable computer shown in FIG. 1;

FIG. 3 is an exemplary cross-sectional view of the portable computer shown in FIG. 1;

FIG. 4 is an exemplary cross-sectional view of the portable computer shown in FIG. 1;

FIG. 5 is an exemplary view showing a relationship between the antenna mounting volume and radiation efficiency;

FIG. 6 is an exemplary cross-sectional view of a portable computer according to a second embodiment of the invention;

FIG. 7 is an exemplary cross-sectional view of a portable computer according to a third embodiment of the invention;

FIG. 8 is an exemplary cross-sectional view of a portable computer according to a fourth embodiment of the invention;

FIG. 9 is an exemplary perspective view of the portable computer shown in FIG. 8;

FIG. 10 is an exemplary cross-sectional view of a portable computer according to a fifth embodiment of the invention;

FIG. 11 is an exemplary cross-sectional view of a portable computer according to a sixth embodiment of the invention;

FIG. 12 is an exemplary cross-sectional view of a portable computer according to a seventh embodiment of the invention;

FIG. 13 is an exemplary cross-sectional view of the portable computer shown in FIG. 12 taken along line F13-F13;

FIG. 14 is an exemplary cross-sectional view of a portable computer according to an eighth embodiment of the invention;

FIG. 15 is an exemplary cross-sectional view of a portable computer according to a ninth embodiment of the invention;

FIG. 16 is an exemplary cross-sectional view of a portable computer according to a tenth embodiment of the invention;

FIG. 17 is an exemplary cross-sectional view of a modification example of the portable computer according to the first to tenth embodiments of the invention;

FIG. 18 is an exemplary cross-sectional view of a portable computer according to an eleventh embodiment of the invention;

FIG. 19 is an exemplary cross-sectional view of a portable computer according to a twelfth embodiment of the invention;

FIG. 20 is an exemplary cross-sectional view of a portable computer according to a thirteenth embodiment of the invention;

FIG. 21 is an exemplary perspective view of the portable computer according to the first to thirteenth embodiments of the invention; and

FIG. 22 is an exemplary perspective view of the portable computer according to the first to thirteenth embodiments of the invention.

### DETAILED DESCRIPTION

Various embodiments according to the invention will be described hereinafter with reference to the accompanying drawings. In general, according to one embodiment of the invention, an electronic apparatus includes a housing, an inner conductor member provided inside the housing, a conductor part with which the housing is provided, and which restrains undesired electromagnetic radiation from leaking from inside the housing to the outside, and an antenna including an antenna element that is provided on an outer surface of the housing, the antenna using the conductor part as an antenna ground. The housing includes a non-conductor part that is out of the conductor part at least at a part of a region in which the antenna element is provided. When the antenna is viewed from a direction in which the antenna element and the housing overlap each other, a size of a part of the antenna element overlapping the non-conductor part is larger than a part of the antenna element overlapping the conductor part.

Embodiments of the present invention will be described below on the basis of drawings of portable computers to which the embodiments are applied.

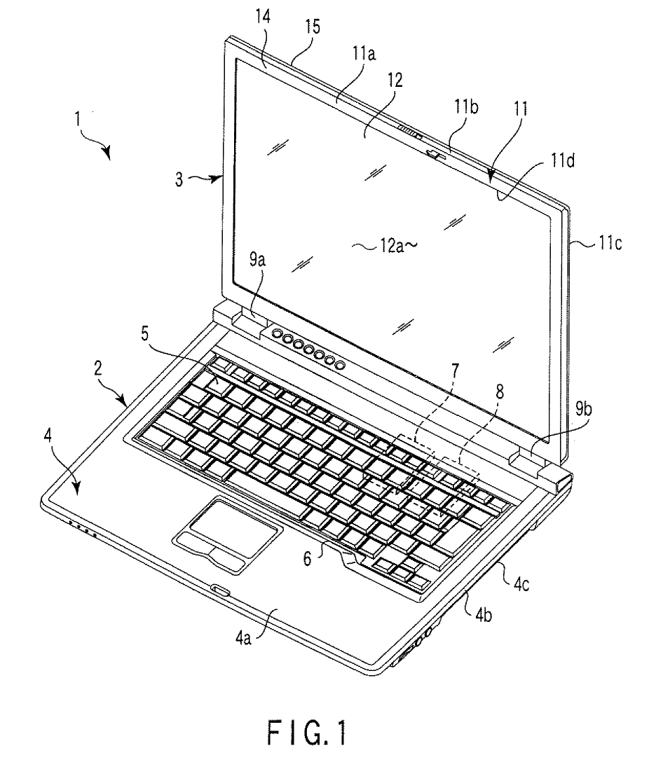

FIGS. 1 to 3 shows a portable computer 1 as an electronic apparatus according to a first embodiment of the present invention. As shown in FIG. 1, a portable computer 1 is provided with a main unit 2, and a display unit 3.

As shown in FIG. 1, the main unit 2 is provided with a main unit housing 4 formed into a box-like shape. The main unit housing 4 includes an upper wall 4a, a peripheral wall 4b, and a lower wall 4c. On the upper wall 4a, a keyboard placing section 6 on which a keyboard 5 is placed is provided.

In the main unit housing 4, a main circuit board (not shown) is provided, and, for example, a plurality of wireless modules 7 and 8 are also provided. Incidentally, various wireless modules compatible with various communication systems to be described later correspond to the wireless modules 7 and 8, and the types of the wireless modules mounted in the electronic apparatus are not particularly limited. Further, the number of wireless modules to be mounted on the portable computer may be one or more than two.

As shown in FIG. 1, one end part of the display unit 3 is supported on a rear end part of the main unit housing 4 through a pair of hinge portions 9a and 9b. As a result of this, the display unit 3 can be turned between a closed position, in which the display unit 3 is laid down to cover the upper wall 4a from above, and an opened position, in which the display unit 3 rises to expose the upper wall 4a.

The display unit 3 is provided with a display unit housing 11 (hereinafter abbreviated as a housing 11), and a display device 12 contained in this housing 11. The display device 12 is an example of an inner conductor member which is provided inside the housing 11. Incidentally, the inner conductor member mentioned in the present invention is not limited to a display device, and various members having electrical conductivity, an electrically conductive layer, and the like provided in the housing 11 correspond to the inner conductor member.

The display device 12 includes a display screen 12a. Examples of the display device 12 are a liquid crystal display, a plasma display, an organic electric luminescence display, a surface-conduction electron-emitter display, and the like, but are not limited to these.

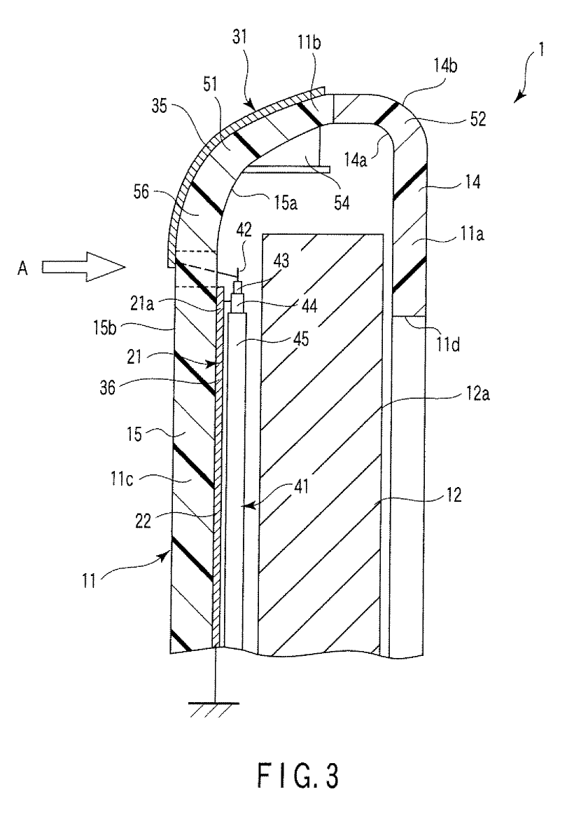

The housing 11 includes a front wall 11a, a peripheral wall 11b, and a rear wall 11c, and is formed into a box-like shape. As shown in FIG. 3, the housing 11 is provided with a mask member 14 including the front wall 11a, and a cover member 15 including the rear wall 11c. The housing 11 is formed by combining the mask member 14 and the cover member 15 with each other. In the front wall 11a of the mask member 14, a relatively large opening 11d that exposes the display screen 12a to the outside of the housing 11 is provided.

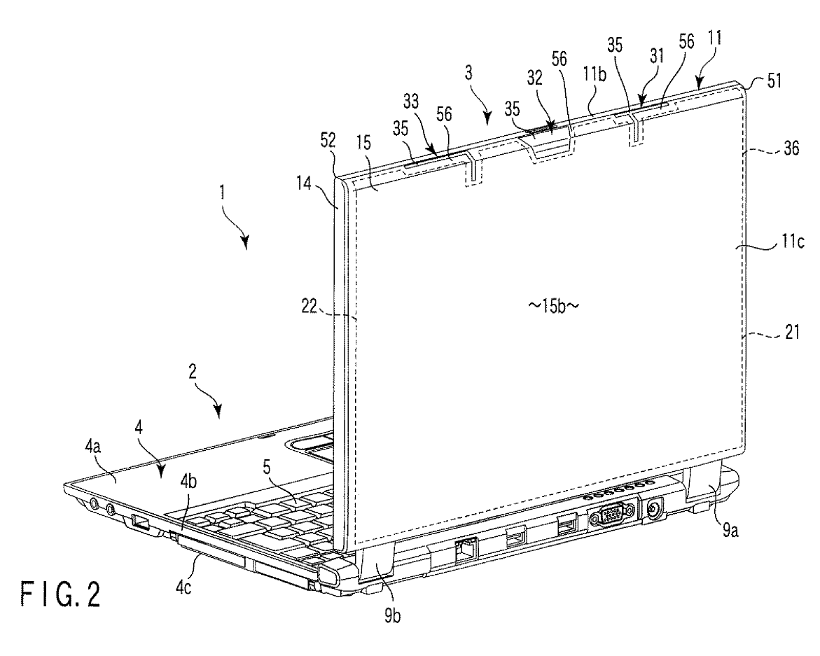

In the housing 11 according to this embodiment, both the mask member 14 and the cover member 15 are made of a synthetic resin material. As shown in FIG. 2, the cover member 15 is provided with a relatively large conductor part 21 as a part of measures for Electro magnet Interference (EMI). The conductor part 21 is provided throughout most of the area of the cover member 15, and is grounded, thereby serving as a shield for restraining undesired electromagnetic radiation from leaking from inside the housing 11 to the outside, and restraining undesired electromagnetic radiation from entering the housing 11 from outside.

As shown in FIG. 3, the conductor part 21 according to this embodiment is provided by a conductor layer 22 provided on an inner surface 15a of the cover member 15. The inner surface 15a of the cover member 15 is an example of an inner surface of the housing 11. This conductor layer 22 is formed by, for example, providing the inner surface 15a of the cover member 15 with an electrically conductive coating layer, or plating the surface 15a, or sticking metallic foil such as an aluminum sheet on the surface 15a.

As shown in FIG. 2, the display unit 3 is provided with a plurality of, for example, three antennas 31, 32, and 33 so as to be integral with the housing 11. Examples of the type of these antennas 31, 32, and 33 are those compatible with the communication systems such as Bluetooth (trade name), wireless Local Area Network (wireless LAN), wireless Wide Area Network (wireless WAN), World wide Interoperability of Microwave Access (WiMAX), Ultra Wide Band (UWB), and Global Positioning System (GPS), or those compatible with the cellular phone systems (i.e., mobile telecommunication systems) such as 3G and 3.5G. However, the types compatible with communication systems other than the above may be used. Incidentally, the number of antennas to be mounted on the portable computer 1 is not particularly limited, and one or a plurality of, for example, two, four or more antennas may be used.

The antenna 31 provided at the rightmost position in FIG. 2 will be described below as an example. Incidentally, as for the other antennas 32 and 33, they have the same configuration and function as the antenna 31 to be described below, and hence the configuration having a function identical with or similar to the antenna 31 is denoted by the identical reference symbol, and a description thereof will be omitted. Incidentally, in the following description, “up” and “down” are defined by regarding the state where the display unit 3 is raised from the main unit 2 as the fundamental posture. That is, an upper end part of the display unit 3 implies the end part thereof opposite to the end part coupled to the hinge portions 9a and 9b.

The antenna 31 includes an antenna element 35 called a radiator, and an antenna ground 36. As shown in FIGS. 2 and 3, the antenna element 35 is provided, at, for example, the upper end part of the display unit 3, on an outer surface 15b of the cover member 15. The outer surface 15b of the cover member 15 is an example of an outer surface of the housing 11.

The antenna element 35 is formed on the outer surface 15b by in-mold fabrication such as IMR and IMF, metal vapor deposition, plating, or sputtering. Further, the antenna 31 uses the conductor part 21 provided on the inner surface 15a of the housing 11 as the antenna ground 36.

More specifically, in the housing 11, a coaxial cable 41 connected to the wireless module 7 extends in the housing 11. FIG. 3 shows schematically the structure of connection of the coaxial cable 41 and the antenna 31 to each other. As shown in FIG. 3, the coaxial cable 41 has, for example, a quadruplex structure, and is provided with a signal section 42, a first insulating section 43 wrapped around the signal section 42, a ground section 44 wrapped around the first insulating section 43, and a second insulating section 45 wrapped around the ground section 44.

The coaxial cable 41 extends from the wireless module 7 to an end part 21a of the conductor part 21 in a state where the cable 41 maintains a constant impedance value, and the ground section 44 and the signal section 42 are exposed to the outside of the coaxial cable 41 at a position in the vicinity of the border between the conductor part 21 and the antenna element 35. The exposed signal section 42 is electrically connected to the antenna element 35. Further, the ground section 44 is electrically connected to the conductor part 21. As a result of this, the antenna 31 uses the conductor part 21 as the antenna ground 36.

The antennas 32, 33 are each an example of the second antenna mentioned in the present invention. Each of the antennas 32, 33 includes an antenna element 35 that is provided on the outer surface 15b of the housing 11, and an antenna ground 36. Ground sections 44 and 44 of coaxial cables 41 and 41 connected to the antennas 32 and 33 mounted on the display unit 3 are electrically connected to the same conductor part 21 to which the ground section 44 of the coaxial cable 41 of the antenna 31 is connected. That is, the one conductor part 21 is shared by the plural antennas 31, 32, and 33 as an antenna ground 36 of each antenna.

Next, a mounting position of the antenna element 35 will be described below in detail.

As shown in FIG. 3, the peripheral wall 11b of the housing 11 extends in a direction intersecting the rear wall 11c. The peripheral wall 11b further extends in a direction intersecting the front wall 11a. The upper end part of the housing 11 is provided with a first curved surface section 51 in which the inner and outer surfaces 15a and 15b of the housing 11 are curved so that the rear wall 11c is smoothly connected to the peripheral wall 11b, and a second curved surface section 52 in which inner and outer surfaces 14a and 14b of the mask member 14 are curved so that the front wall 11a is smoothly connected to the peripheral wall 11b. An inner space of the upper end part of the housing 11 provided with the curved surface sections 51 and 52 is tapered to be thinner towards the end thereof, and hence the space is a region not suitable for containing the display device 12 therein. For this reason, the display device 12 is provided in, for example, a region in the housing 11 outside the curved surface sections 51 and 52. The “region outside curved surface sections 51 and 52” mentioned in this description implies a region in the space of the housing 11 that does not overlap a part of each of the curved surface sections 51 and 52 having the maximum curvature when viewed from a direction of an arrow A as will be described later. By providing the display device 12 in the region outside the curved surface sections 51 and 52, it is possible to contain the display device 12 even in a housing 11 including large curved surface sections 51 and 52 without increasing the thickness of the housing 11.

As shown in FIG. 3, the curved surface section 51 is provided with, for example, an inner structure 54 protruding from the inner surface 15a of the housing 11 toward the inside of the housing 11. The inner structure 54 is, for example, a T-rib for maintaining the strength of the housing 11, a boss in which a threaded hole for fixing is formed, a claw for fixing the mask member 14 to the cover member 15, a latch member or the like.

Further, as shown in FIGS. 2 and 3, the upper end part of the housing 11 includes a non-conductor part 56 that is outside the conductor part 21. Incidentally, the non-conductor part 56 according to this embodiment implies a region of the cover member 15 in which the conductor layer 22 is not provided. The non-conductor part 56 is formed by, for example, cutting out a part of the conductor layer 22. In this embodiment, the non-conductor part 56 includes a part of the first curved surface section 51 and a part of the rear wall 11c formed into a flat surface.

The non-conductor part 56 is provided at least at a part of a region in which the antenna element 35 is provided. The entirety of the antenna element 35 according to this embodiment is provided on the outer surface 15b of the non-conductor part 56. That is, the antenna element 35 is provided in the region formed by cutting out the conductor layer 22. Hence, the entirety of the antenna element 35 is provided so as to be completely out of the conductor part 21. As a result of this, when the antenna 31 is viewed from a direction in which the antenna element 35 and the housing 11 overlap each other, a size of a part of the antenna element 35 overlapping the non-conductor part 56 is larger than a size of a part of the antenna element 35 overlapping the conductor part 21.

That is, in this embodiment, the antenna element does not overlap the conductor part 21, and hence the size of the part of the antenna element 35 overlapping the conductor part 21 is zero. Incidentally, the direction in which the antenna element 35 and the housing 11 overlap each other implies the direction of the arrow A in FIG. 3. Further, the “size” mentioned herein is an area in the case of a planar antenna, and is a projected area in the case of a solid antenna (i.e., three-D antenna).

As shown in FIG. 3, the antenna element 35 is provided such that the antenna element extends from a part of the rear wall 11c formed into a flat surface to the first curved surface section 51. That is, at least a part of the antenna element 35 is provided in the first curved surface section 51. In addition to the above, at least a part of the antenna element 35 is provided in a region in which the inner structure 54 is provided.

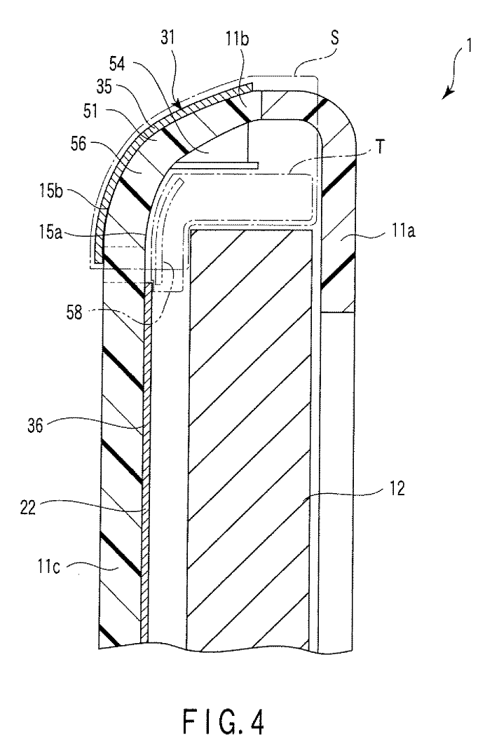

According to the portable computer 1 configured as described above, high antenna performance can be realized. In the housing 11, the inner structure 54 such as a rib and a boss is provided, and hence it is difficult to secure a sufficient space for mounting the antenna. For this reason, an antenna 58 to be provided inside the housing 11, which is shown by the two dotted line in FIG. 4, is provided so as to avoid the inner structure 54, and hence the size of the antenna cannot be made so large.

On the other hand, since the antenna 31 according to this embodiment is provided on the outer surface 15b of the housing 11, the size of the antenna 31 is not limited by the inner structure 54. This makes it possible to easily make the size of the antenna 31 large, and improve the antenna performance.

Moreover, the mounting position of the antenna 31 is not limited by the inner structure 54, and hence it is possible to arrange the antenna 31 at an arbitrary position at which the required directivity can be obtained. This contributes to improvement of the antenna performance.

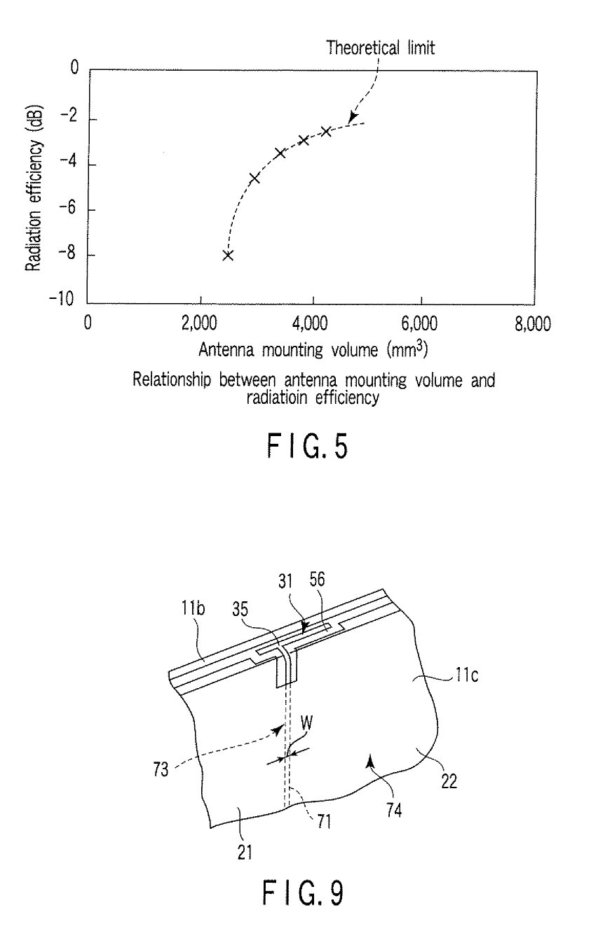

Next, the “antenna mounting volume” will be described below. The “antenna mounting volume” can be defined in various ways. In this description, the antenna mounting volume implies a space defined by the antenna element 35 and inner conductor members (in this embodiment, the display device 12 and the conductor layer 22). Here, FIG. 5 shows a relationship between the antenna mounting volume and radiation efficiency verified by the present inventors. As shown in FIG. 5, it is understood that when the antenna mounting volume becomes large, the theoretical limit value of the radiation efficiency is improved. That is, it can be seen that an antenna 31 for which a large antenna mounting volume is secured can exhibit high performance.

The one dotted line S in FIG. 4 indicates the antenna mounting volume of the antenna 31 according to this embodiment. Further, the one dotted line T in FIG. 4 indicates the antenna mounting volume of the antenna 58 to be provided inside the housing 11. As described above, according to the antenna 31 provided on the outer surface 15b of the housing 11, the antenna 31 can be mounted separate from inner conductor members inside the housing 11, and hence the antenna mounting volume can be secured in a large volume. This makes it possible for the antenna 31 to improve, for example, the antenna gain, and exhibit higher performance.

To describe the above differently, it can be said that when the antenna element 35 is provided on the outer surface 15b of the housing 11, high antenna performance can be secured with respect to the size of the given portable computer 1. Therefore, according to such an antenna mounting structure, size reduction of the portable computer 1 can be realized. Further, when the antenna element 35 is provided on the outer surface 15b of the housing 11, the freedom of the mounting position of the antenna 31 is high, and thus a higher number of antennas can be mounted, as the need arises.

By using the conductor part 21 of the housing 11 that plays a role of a shield as the antenna ground 36, it becomes unnecessary to separately form another antenna ground 36 in the housing 11. If it is unnecessary to separately form another antenna ground 36, both the size of the conductor part 21 and the size of the antenna element 35 can be made large with respect to in the housing 11 having the limited size. This makes it possible to further restrain undesired electromagnetic radiation from leaking, and realize higher antenna performance.

If it is temporarily assumed that the conductor layer 22 is provided over almost the entire region of the inner surface 15a of the housing 11, and a large part of the antenna element 35 overlaps the conductor layer 22 when the element 35 and the layer 22 are viewed from a direction in which the antenna element 35 and the housing 11 overlap each other, the antenna mounting volume becomes a very small volume defined by the antenna element 35 and the conductor layer 22.

The present inventors have found that with such an antenna mounting structure, the employable antenna types are restricted. That is, as some of the antenna types, even such antenna structures can sufficiently function. However, depending on the antenna type, part of an electric wave to be radiated from the antenna element 35 is not actually radiated and is caused to flow to the antenna ground 36. It has been found that the freedom of antenna design is not so high, and there is yet room for improvement in order to realize high antenna performance.

On the other hand, if the housing 11 is provided with the non-conductor part 56 as in this embodiment, and the size of the part of the antenna element 35 overlapping the non-conductor part 56 is larger than the size of the part of the antenna element 35 overlapping the conductor part 21, the antenna mounting volume can be secured in a large volume. Furthermore, the electric wave to be radiated from the antenna element 35 is not caused to flow to the antenna ground 36, but is radiated to the outside. Thus, high antenna performance can be realized. According to the mounting structure of this embodiment, the antenna types are not restricted, and hence it san be said that the freedom of antenna design is enhanced, and high antenna performance can be realized.

To summarize the above description, according to such an antenna mounting structure, the housing 11 is provided with the non-conductor part 56 to thereby secure the antenna mounting volume in a large volume, and in addition to this, it is made possible to omit the mounting space of the antenna ground 36, whereby it is possible to make the conductor part 21 for EMI which is originally obliged to be made smaller due to the presence of the non-conductor part 56 sufficiently large. This makes it possible to obtain a portable computer 1 in which high antenna performance and high electromagnetic wave shielding capability are made compatible with each other.

Particularly when the entirety of the antenna element 35 is provided in the non-conductor part 56, the antenna mounting volume can be secured in a larger volume. This makes it possible to realize higher antenna performance.

When the antenna element 35 is mounted on the outer surface 15b of the housing 11 in the curved surface section 51 in which the surfaces 15a and 15b are curved, it is easier to form the antenna element large as compared with the case where the antenna element is provided on the inner surface 15a of the housing 11. Accordingly, when the antenna element 35 is provided on the curved surface section 51, it is possible to enhance the effect to be exhibited by providing the antenna element 35 on the outer surface 15b of the housing 11.

Furthermore, it is difficult to mount an inner conductor member such as the display device 12 in close proximity to the surface 15a of the housing 11 due to the curved shape of the curved surface section 51. For this reason, if the antenna 31 is mounted on the curved surface section 51, it is easy to secure a distance between the antenna 31 and the inner conductor member. That is, it can be said that the curved surface section 51 is a region in which the antenna mounting volume can easily be secured. When the inner conductor member is mounted in a region out of the curved surface section 51 in the housing 11, the antenna mounting volume is further increased, and hence it becomes possible to realize higher antenna performance.

When at least a part of the antenna element 35 is provided in the region in which the inner structure 54 is provided, it can be said that the region in which mounting is not originally enabled due to the presence of the inner structure 54 is effectively utilized. By effectively utilizing such an originally idle region to provide the antenna element 35, it is possible to make, for example, the size of the antenna element 35 larger, and further improve the antenna performance.

The conductor part 21 for EMI is provided on the cover member 15 in which it is easier to secure a large area as compared with the mask member 14. When the antenna element 35 is provided on the same cover member 15, i.e., when the antenna ground 36 and the antenna element 35 are provided on the same member, it is easy to electrically connect the coaxial cable 41 to the antenna ground 36 and the antenna element 35.

When the conductor part 21 and the antenna element 35 are provided in proximity to each other, it is possible to extend the coaxial cable 41 maintaining the predetermined impedance to the border part between the conductor part 21 and the antenna element 35, and separate the coaxial cable 41 into the ground section 44 and the signal section 42 first at the border between the conductor part 21 and the antenna element 35. This makes the power supply loss smaller.

When the plural antennas 31, 32, and 33 share the one conductor part 21 with one another as the antenna ground 36 of each of them, it is not necessary to provide the antenna ground separately, and hence the structure of the display unit 3 can be made simpler.

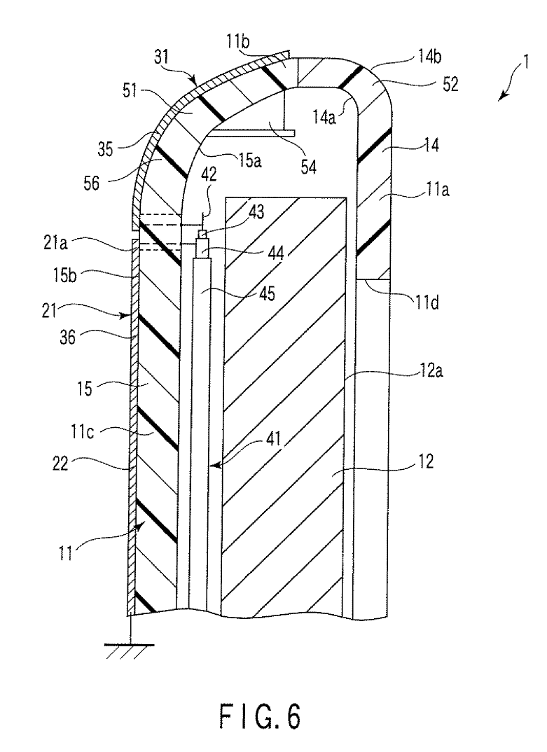

Next, a portable computer 1 as an electronic apparatus according to a second embodiment of the present invention will be described below with reference to FIG. 6. Incidentally, a configuration having functions identical with or similar to those of the portable computer 1 according to the first embodiment is denoted by the same reference symbol, and a description thereof is omitted. The second embodiment differs from the first embodiment in the place where a conductor layer 22 is provided, and the fundamental configuration of the portable computer is identical with the first embodiment.

As shown in FIG. 6, a conductor part 21 according to this embodiment is formed by a conductor layer 22 provided on an outer surface 15b of a cover member 15. The conductor layer 22 is formed by, for example, in-mold fabrication, metal vapor deposition, plating, sputtering or the like. The conductor part 21 serves as an antenna ground 36, and also functions as a shield for EMI.

An antenna element 35 is provided so that antenna element 35 is completely out of the conductor part 21, and the antenna element 35 does not overlap the conductor part 21 when they are viewed from a direction in which the antenna element 35 and a housing 11 overlap each other.

According to the portable computer 1 configured as described above, high antenna performance can be realized as well as the first embodiment. When the conductor layer 22 is provided on the same surface 15b on which the antenna element 35 is provided, the conductor layer 22 and the antenna element 35 can be collectively formed at the same time by, for example, in-mold fabrication, metal vapor deposition, plating, sputtering or the like.

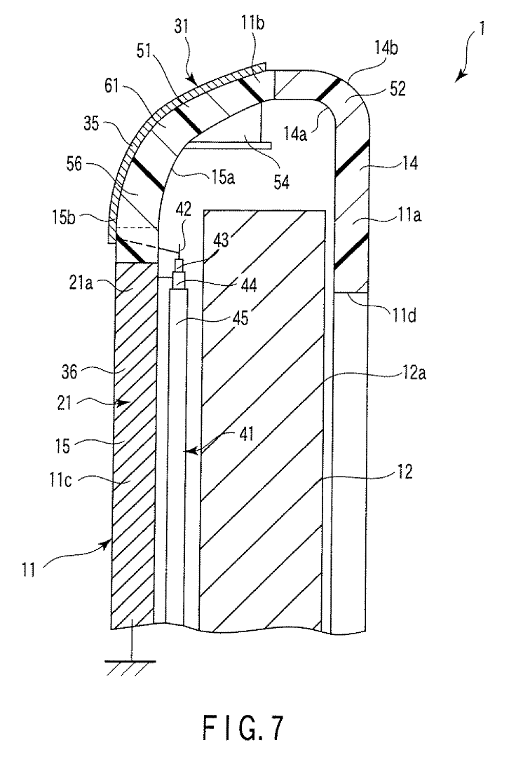

Next, a portable computer 1 as an electronic apparatus according to a third embodiment of the present invention will be described below with reference to FIG. 7. Incidentally, a configuration having functions identical with or similar to those of the portable computer 1 according to the first embodiment is denoted by the same reference symbol, and a description thereof is omitted. The third embodiment differs from the first embodiment in the place where a conductor part 21 is provided, and the fundamental configuration of the portable computer is identical with the first embodiment.

As shown in FIG. 7, a housing 11 is provided with a mask member 14 including a front wall 11a, a cover member 15 including a rear wall 11c, and a corner member 61 including a part of a peripheral wall 11b and a part of the rear wall 11c. The corner member 61 includes a first curved surface section 51, and is a part of an upper end part of the housing 11. The mask member 14 and the corner member 61 are made of a synthetic resin material. The cover member 15 according to this embodiment is made of, for example, a metallic material such as a magnesium alloy.

The cover member 15 made of a metal is grounded, and becomes a conductor part 21 for restraining undesired electromagnetic radiation from leaking from inside the housing 11 to the outside, and restraining undesired electromagnetic radiation from entering the housing 11 from outside. The corner member 61 becomes a non-conductor part 56. An antenna element 35 is provided to extend from the flat rear wall 11c to the first curved surface section 51, and does not overlap the cover member 15 made of a metal.

A ground section 44 and a signal section 42 of a coaxial cable 41 are exposed to the outside of the coaxial cable 41 at a position in the vicinity of the border between the cover member 15 and the corner member 61, the signal section 42 is electrically connected to the antenna element 35, and the ground section 44 is electrically connected to the cover member 15. Incidentally, when a plurality of antennas 31, 32, and 33 are provided, these plural antennas 31, 32, and 33 share the one cover member 15 with one another as an antenna ground 36 of each of the antennas 31, 32, and 33.

According to the portable computer 1 configured as described above, it becomes possible to realize high antenna performance as well as the first embodiment.

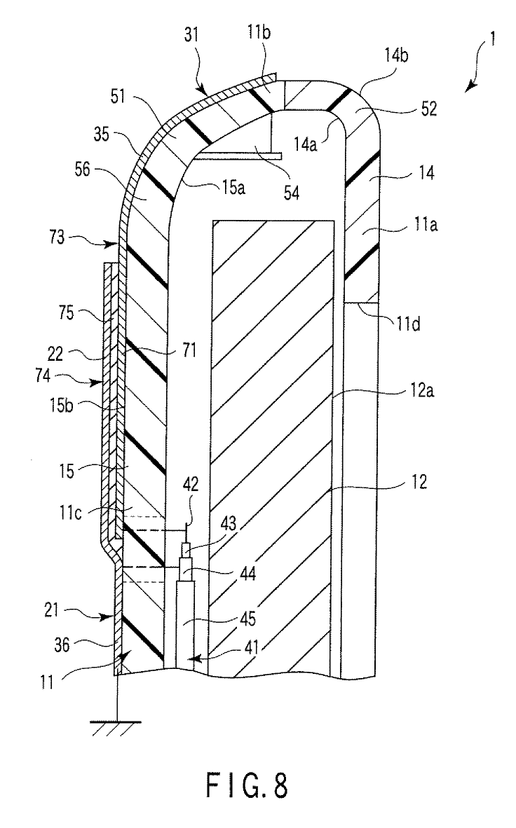

Next, a portable computer 1 as an electronic apparatus according to a fourth embodiment of the present invention will be described below with reference to FIGS. 8 and 9. Incidentally, a configuration having functions identical with or similar to those of the portable computer 1 according to the first embodiment is denoted by the same reference symbol, and a description thereof is omitted. The fourth embodiment differs from the first embodiment in the point that the fourth embodiment is provided with a signal line 71 arranged on an outer surface 15b of a housing 11, and the fundamental configuration of the portable computer is identical with the first embodiment.

As shown in FIG. 8, on the outer surface 15b of a housing 11, a plurality of conductive layers 73 and 74 are provided such that they overlap each other by repeatedly performing, for example, in-mold fabrication, metal vapor deposition, plating, or sputtering. The one conductive layer 73 forms an antenna element 35, and a signal line 71 used to supply electricity to the antenna element 35. The signal line 71 is formed integral with the antenna element 35.

On the other hand, the other conductive layer 74 is a conductor layer 22 which serves as a conductor part 21. As shown in FIGS. 8 and 9, this conductive layer 74 (i.e., conductor layer 22) is provided in a region opposed to the signal line 71, and covers the signal line 71. A dielectric substance 75 is provided between the conductive layer 74 and the signal line 71. As a result of this, the part of the conductive layer 73 covered with the conductive layer 74 becomes the signal line 71, and the part of the conductive layer 73 out of the conductive layer 74 becomes the antenna element 35.

In the vicinity of a proximal part of the signal line 71, a ground section 44 and a signal section 42 of a coaxial cable 41 are exposed to the outside of the coaxial cable 41. The exposed signal section 42 is electrically connected to the signal line 71. The exposed ground section 44 is electrically connected to the conductor layer 22.

A line width W of the signal line 71 is set in such a manner that the impedance between, for example, the conductive layer 74 and the signal line 71 matches with the input/output impedance of a wireless module 7 connected to an antenna 31. The line width W of the signal line 71 is set in such a manner that, for example, when the input/output impedance of the wireless module 7 is 50Ω, the impedance between the conductive layer 74 and the signal line 71 becomes 50Ω.

According to the portable computer 1 configured as described above, high antenna performance can be realized as well as the first embodiment. Further, when the signal line 71 is provided on the outer surface 15b of the housing 11, power can be supplied to the antenna element 35 without drawing the coaxial cable 41 up to a position in the vicinity of the antenna element 35. That is, it is possible to provide the antenna element 35 even at a position to which the coaxial cable 41 cannot be drawn. This enhances the freedom of antenna mounting, and enables the antenna performance to be improved. Further, when the signal line 71 and the antenna element 35 can be formed integral with each other, the manufacturability of the portable computer 1 is good.

When the line width W of the signal line 71 is set in such a manner that the impedance between the conductive layer 74 and the signal line 71 matches with the input/output impedance of the wireless module 7 connected to the antenna 31, it is possible to suppress the power supply loss with respect to the antenna element 35.

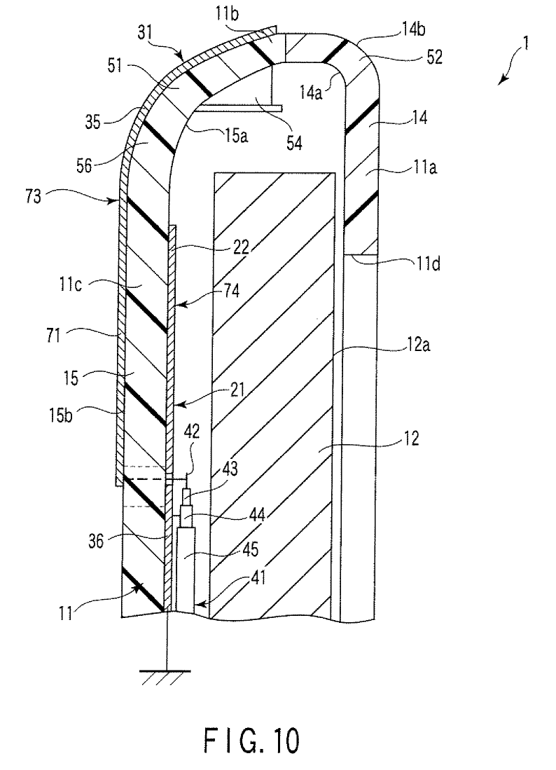

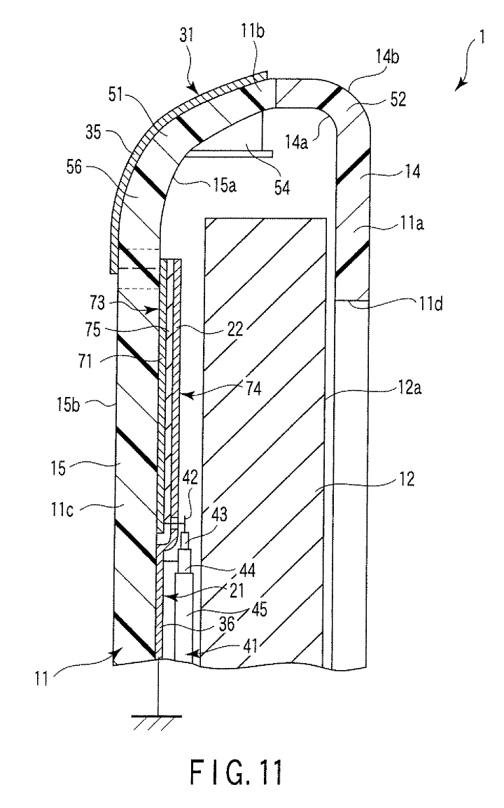

Next, a portable computer 1 as an electronic apparatus according to a fifth embodiment of the present invention will be described below with reference to FIG. 10. Incidentally, a configuration having functions Identical with or similar to those of the portable computers 1 according to the first and fourth embodiments is denoted by the same reference symbol, and a description thereof is omitted. The fifth embodiment differs from the fourth embodiment in the place where a conductive layer 74 is provided, and the fundamental configuration of the portable computer is identical with the first embodiment.

As shown in FIG. 10, on an outer surface 15b of a housing 11, a conductive layer 73 is provided by, for example, in-mold fabrication, metal vapor deposition, plating, sputtering or the like. This conductive layer 73 forms an antenna element 35, and a signal line 71 used to supply electricity to the antenna element 35. On the other hand, a conductive layer 74 is provided on an inner surface 15a of the housing 11. This conductive layer 74 is a conductor layer 22 which serves as a conductor part 21.

This conductive layer 74 is provided in a region opposed to the signal line 71. The housing 11 serving as a dielectric substance is interposed between the conductive layer 74 and the signal line 71. As a result of this, the part of the conductive layer 73 overlapping the conductive layer 74 becomes the signal line 71, and the part of the conductive layer 73 out of the conductive layer 74 becomes the antenna element 35. A line width W of the signal line 71 is set in such a manner that the impedance between, for example, the conductive layer 74 and the signal line 71 matches with the input/output impedance of a wireless module 7 connected to an antenna 31.

According to the portable computer 1 configured as described above, high antenna performance can be realized as well as the first embodiment. Further, when the signal line 71 is provided on the outer surface 15b of the housing 11, it is possible to provide the antenna element 35 even at a position to which the coaxial cable 41 cannot be drawn.

Next, a portable computer 1 as an electronic apparatus according to a sixth embodiment of the present invention will be described below with reference to FIG. 11. Incidentally, a configuration having functions identical with or similar to those of the portable computers 1 according to the first and fourth embodiments is denoted by the same reference symbol, and a description thereof is omitted. The sixth embodiment differs from the fourth embodiment in the place where conductive layers 73 and 74 are provided, and the fundamental configuration of the portable computer is identical with the first embodiment.

As shown in FIG. 11, on an inner surface 15a of a housing 11, conductive layers 73 and 74 are provided by, for example, in-mold fabrication, metal vapor deposition, plating, sputtering or the like. The one conductive layer 73 is electrically connected to an antenna element 35, and forms a signal line 71 used to supply electricity to the antenna element 35.

The other conductive layer 74 is a conductor layer 22 which serves as a conductor part 21.

This conductive layer 74 is provided in a region opposed to the signal line 71. A line width W of the signal line 71 is set in such a manner that the impedance between, for example, the conductive layer 74 and the signal line 71 matches with the input/output impedance of a wireless module 7 connected to an antenna 31.

According to the portable computer 1 configured as described above, high antenna performance can be realized as well as the first embodiment. Further, when the signal line 71 is provided on the inner surface 15a of the housing 11, it is possible to provide the antenna element 35 even at a position to which the coaxial cable 41 cannot be drawn.

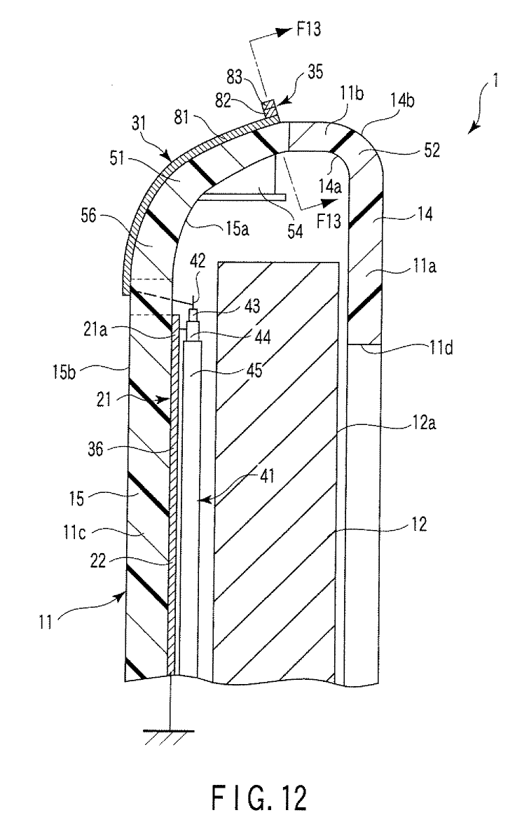

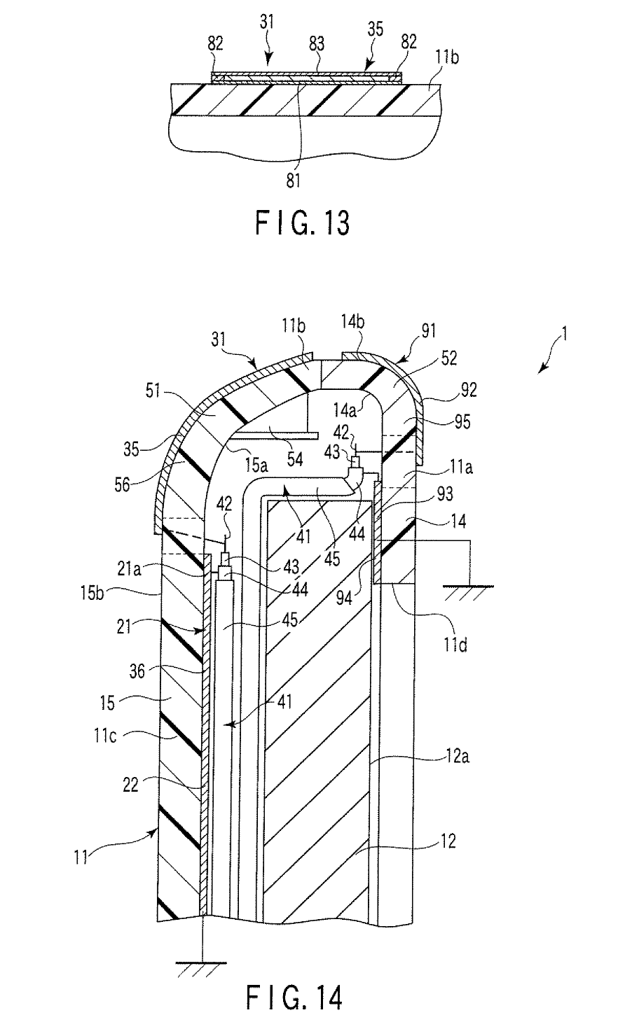

Next, a portable computer 1 as an electronic apparatus according to a seventh embodiment of the present invention will be described below with reference to FIGS. 12 and 13. Incidentally, a configuration having functions identical with or similar to those of the portable computer 1 according to the first embodiment is denoted by the same reference symbol, and a description thereof is omitted. The seventh embodiment differs from the first embodiment in the structure of an antenna element 35, and the fundamental configuration of the portable computer is identical with the first embodiment.

As shown in FIGS. 12 and 13, an antenna element 35 is formed by multilayer conductor layers 81, 82, and 83. This antenna element 35 is formed by repeatedly performing, for example, in-mold fabrication, metal vapor deposition, plating, sputtering or the like. As shown in FIG. 13, the antenna element 35 forms, for example, a loop antenna that loops continuously.

According to the portable computer 1 configured as described above, high antenna performance can be realized as well as the first embodiment. Further, when the antenna element 35 is formed by the multilayer conductor layers, an antenna element having a complicated shape can be formed in a small area. This makes it possible to realize high antenna performance, and further reduce the size of the portable computer 1.

Next, a portable computer 1 as an electronic apparatus according to an eighth embodiment of the present invention will be described below with reference to FIG. 14. Incidentally, a configuration having functions identical with or similar to those of the portable computer 1 according to the first embodiment is denoted by the same reference symbol, and a description thereof is omitted. The eighth embodiment differs from the first embodiment in being provided with another antenna 91, and the fundamental configuration of the portable computer is identical with the first embodiment.

As shown in FIG. 14, another antenna 91 is mounted on a mask member 14. The antenna 91 includes an antenna element 92, and an antenna ground 93. The antenna element 92 is provided on an outer surface 14b of the mask member 14 by, for example, in-mold fabrication, metal vapor deposition, plating, or sputtering. Further, the antenna 91 uses a conductor layer 94 provided on an inner surface 14a of the mask member 14 as an antenna ground 36. Incidentally, the conductor layer 94 may also be one which is provided as an antenna ground 36, and may also be, for example, one which is provided as a conductor part 21 for restraining undesired electromagnetic radiation from leaking from inside the housing 11 to the outside.

The mask member 14 is provided with a non-conductor part 95 which is out of conductor layer 94. No conductive layer 94 is provided on the non-conductor part 95. The non-conductor part 95 according to this embodiment includes a part of both a second curved surface section 52 and a front wall 11a formed flat. When the antenna 31 is viewed from a direction in which the antenna element 92 and the housing 11 overlap each other, a size of a part of the antenna element 92 overlapping the non-conductor part 95 is larger than a size of a part of the antenna element 92 overlapping the conductor layer 94.

The entirety of the antenna element 92 according to this embodiment is provided on the outer surface 14b of the non-conductor part 95. That is, the antenna element 92 is so provided as to be completely out of the conductor layer 94, and does not overlap the conductor layer 94. As shown in FIG. 14, the antenna element 92 is provided to extend from a part of the front wall 11a formed flat to the second curved surface section 52. That is, at least a part of the antenna element 92 is provided on the second curved surface section 52.

According to the portable computer 1 configured as described above, high antenna performance can be realized as well as the first embodiment. Further, when the antenna 91 is mounted on the mask member 14 too, the number and the types of the antennas can be increased, and the antenna performance is improved.

When the antenna element 92 is provided also on the outer surface 14b of the mask member 14, it is possible to make a distance between the antenna element 92 provided on the mask member 14 and an antenna element 35 provided on a cover member 15 large. This makes it possible to secure the antenna mounting volume of each of the two antennas 31 and 91 in a large volume.

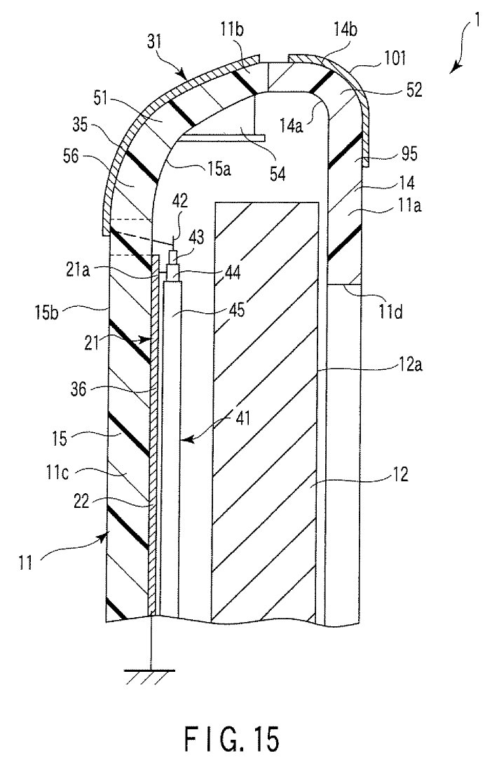

Next, a portable computer 1 as an electronic apparatus according to a ninth embodiment of the present invention will be described below with reference to FIG. 15. Incidentally, a configuration having functions identical with or similar to those of the portable computer 1 according to the first embodiment is denoted by the same reference symbol, and a description thereof is omitted. The ninth embodiment differs from the first embodiment in being provided with a passive element 101, and the fundamental configuration of the portable computer is identical with the first embodiment.

As shown in FIG. 15, the portable computer 1 is provided with a passive element 101 (i.e., parasitic element). The passive element 101 is provided in another region of a housing 11 opposed to a region in which an antenna element 35 is provided. The passive element 101 is provided on an outer surface 14b of a mask member 14 by, for example, in-mold fabrication, metal vapor deposition, plating, or sputtering. The mask member 14 is a non-conductor part 95.

Various things correspond to the passive element 101, and specific examples are a reflector for imparting directivity to an electric wave, a director for guiding an electric wave to the antenna element 35, a resonant element for causing an antenna 31 to perform multiple resonance, and the like.

According to the portable computer 1 configured as described above, the antenna performance is improved, as in the first embodiment. Further, when the passive element 101 is provided, various effects such as improvement in adjustment or a gain of the antenna 31, and multiple resonance, and the like can be obtained. When the passive element 101 is provided on the outer surface 14b of the mask member 14, a size and shape of the passive element 101 can be freely designed without being restricted by the internal structure of the housing 11, and hence the antenna performance is improved.

When a conductor layer 22 which serves as an antenna ground 36 is provided on a cover member 15, the mask member 14 becomes one of parts at which electrical supply is relatively difficult. In this case, when a coaxial cable 41 is prolonged in a state where a signal section 42 and a ground section 44 are separated from each other, the power supply loss becomes large, which is undesirable. Further, for example, when the conductor layer 22 is provided to extend to a distal end part of a peripheral wall 11b, there is the possibility of an electric wave traveling toward the rear side thereof being weakened, and adjustment of the directivity becoming difficult.

On the other hand, the passive element 101 requires no electrical supply, and hence there is no need to draw a coaxial cable 41 to the passive element 101. In this embodiment, the conductor part 21 for EMI is provided, the antenna element 35 is provided on the cover member 15 where electrical supply is relatively easy, and the passive element 101 is provided on the mask member 14 at which electrical supply is relatively difficult. This makes it possible to easily provide the antenna element 35 and the passive element 101.

When the passive element 101 is provided on the outer surface 14b of the mask member 14, it is possible to make a distance between the passive element 101 and the antenna element 35 large. This makes it possible to secure the antenna mounting volume of the antenna 31 in a large volume.

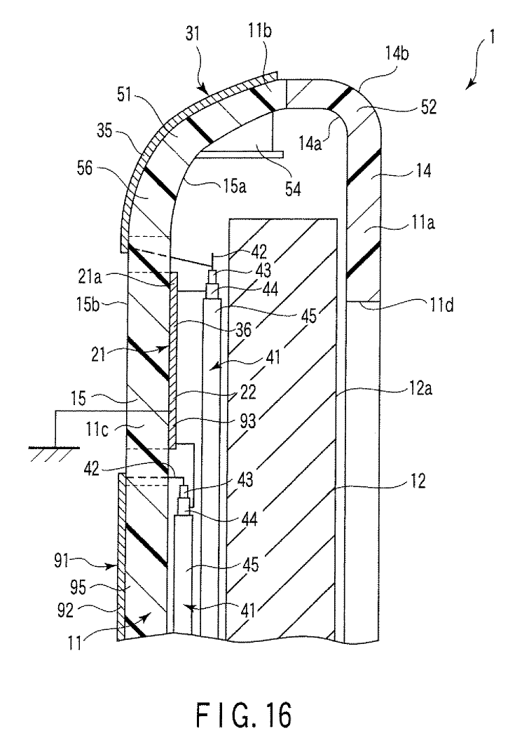

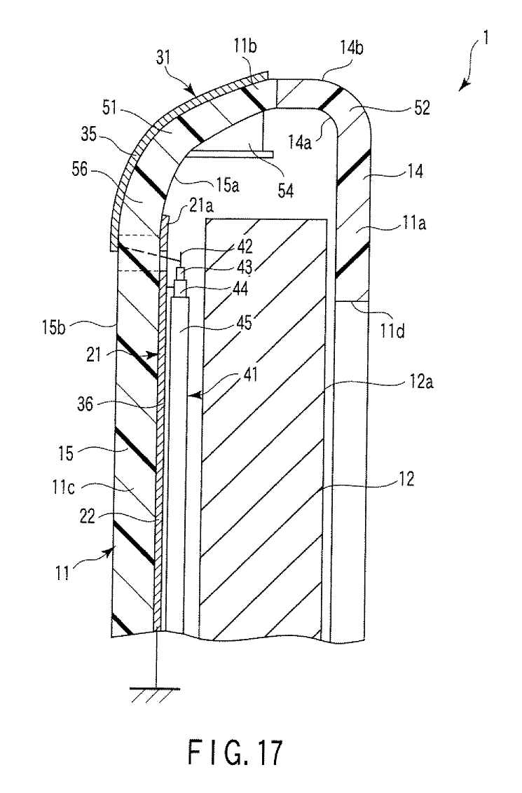

Next, a portable computer 1 as an electronic apparatus according to a tenth embodiment of the present invention will be described below with reference to FIG. 16. Incidentally, a configuration having functions identical with or similar to those of the portable computer 1 according to the first embodiment is denoted by the same reference symbol, and a description thereof is omitted. The tenth embodiment differs from the first embodiment in being provided with another antenna 91, and the fundamental configuration of the portable computer is identical with the first embodiment.

The portable computer 1 is provided with another antenna 91. This antenna 91 includes an antenna element 92 and an antenna ground 93. The antenna element 92 is provided on an outer surface 15b of a housing 11. Further, both an antenna 31 and the antenna 91 share one conductor part 21 with each other as an antenna ground 36 or 93 of each of them.

The conductor part 21 is not provided in a region opposed to the antenna element 92. That is, when the antenna 31 is viewed from a direction in which the antenna element 92 and the housing 11 overlap each other, a size of a part of the antenna element 92 overlapping a non-conductor part 95 is larger than a size of the antenna element 92 overlapping the conductor part 21.

According to the portable computer 1 configured as described above, high antenna performance can be realized as well as the first embodiment. Further, when the plural antennas 31 and 91 share the conductor part 21 with each other as an antenna ground 36 or 93 of each of them, there is no need to separately provide a ground, and hence the structure of a display unit 3 can be made simpler.

The portable computers according to the first to tenth embodiments have been described above. However, the present invention is not limited to these. As shown in FIG. 17, for example, the antenna element 35 and the conductor part 21 need not be provided in a state where they are completely shifted from each other and, for example, the antenna element 35 and the conductor part 21 may partly overlap each other.

As follows, some embodiments according to another aspect of the invention will be described below.

An electronic apparatus according to another aspect of the invention includes a housing; an inner conductor member provided in the housing; and an antenna including an antenna element and an antenna ground. The antenna element is provided on an outer surface of the housing. The antenna ground is provided on the outer surface of the housing on which the antenna element is provided.

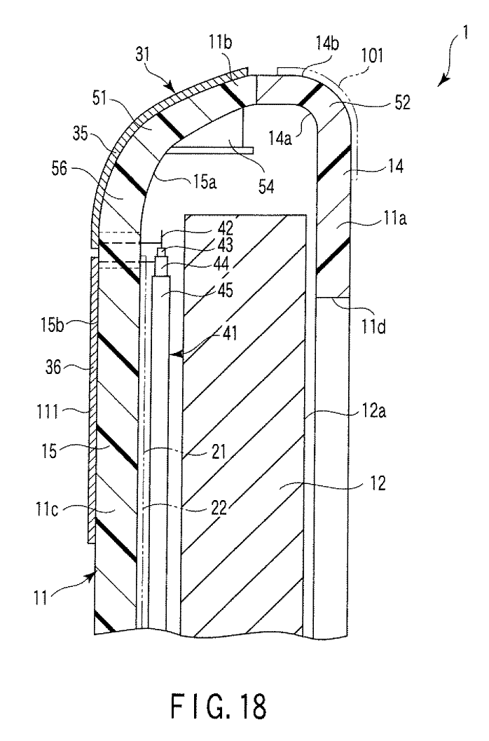

Next, a portable computer 1 as an electronic apparatus according to an eleventh embodiment of the present invention will be described below with reference to FIG. 18. Incidentally, a configuration having functions identical with or similar to those of the portable computer 1 according to the first embodiment is denoted by the same reference symbol, and a description thereof is omitted. The eleventh embodiment differs from the first embodiment in the function of a conductor layer, and the fundamental configuration of the portable computer is identical with the first embodiment.

A conductor layer 111 is provided on an outer surface 15b of a cover member 15. The conductor layer 111 is not associated with EMI, and functions purely as an antenna ground 36. An antenna 31 includes the antenna ground 36, and an antenna element 35 provided on an outer surface 15b of a housing 11. That is, the antenna ground 36 is provided on the surface 15b on which the antenna element 35 is provided. The antenna element 35 and the antenna ground 36 are formed on the surface 15b at a time by, for example, in-mold fabrication such as IMR and IME, metal vapor deposition, plating, or sputtering.

Next, the mounting position of the antenna element 35 will be described below in detail.

As shown in FIG. 18, an upper end part of the housing 11 is provided with curved surface sections 51 and 52. A display device 12 which is an inner conductor member is provided in, for example, a region out of the curved surface sections 51 and 52 in the housing 11.

At least a part of the antenna element 35 is provided on the curved surface section 51. When the antenna 31 is viewed from a direction in which the antenna element 35 and the housing 11 overlap each other, a size of a part of the antenna element 35 overlapping the inner conductor member (i.e., the display device 12) is smaller than a size of a part of the antenna ground 36 overlapping the inner conductor member.

According to the portable computer 1 configured as described above, high antenna performance can be realized. When the antenna element 35 is provided on the outer surface 15b of the housing 11, the size and position of the antenna element 35 are not limited by the inner structure 54. This makes it possible to improve the antenna performance.

When the antenna 31 is viewed from a direction in which the antenna element 35 and the housing 11 overlap each other, if a size of a part of the antenna element 35 overlapping the inner conductor member is smaller than a size of a part of the antenna ground 36 overlapping the inner conductor member, the antenna mounting volume can be secured in a large volume. This enables the antenna 31 to have the antenna gain improved, and exhibit higher performance.

The present inventors have found that the antenna mounting structure in which the antenna element 35 is provided on the outer surface 15b of the housing 11, and the antenna ground 36 is separately provided inside the housing 11 still has room for improvement from the viewpoint of manufacturability.

In the antenna mounting structure according to this embodiment, the antenna ground 36 is provided on the surface 15b on which the antenna element 35 is formed. According to the antenna ground 36 provided in the manner described above, it is possible to simultaneously form the antenna ground 36 and the antenna element 35 on the outer surface 15b by, for example, in-mold fabrication, metal vapor deposition, plating, or sputtering This makes it possible to obtain a portable computer 1 capable of realizing high manufacturability.

Moreover, it can be said that the antenna structure according to this embodiment can exhibit effectiveness thereof particularly easily when no conductive layer 22 is present on the inner surface 15a of the housing 11. Incidentally, the portable computer 1 according to this embodiment may be provided with a conductor layer 22 for EMI on the inner surface 15a of the housing 11. In this case, the conductor layer 22 corresponds to an example of the inner conductor member.

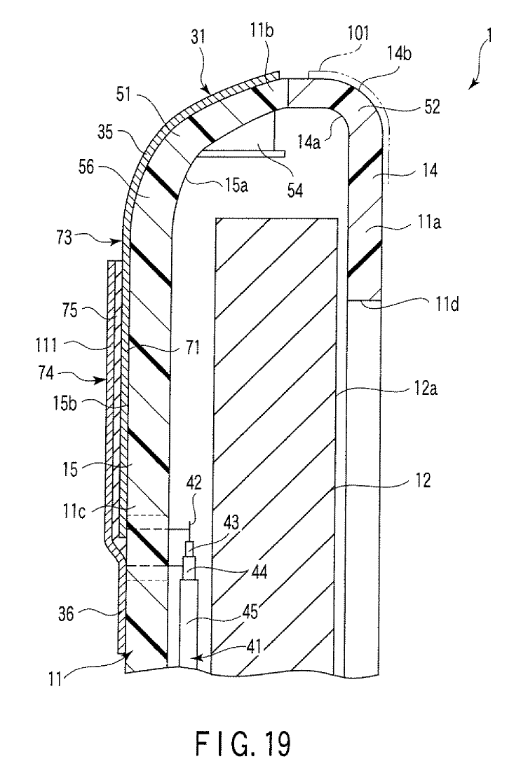

Next, a portable computer 1 as an electronic apparatus according to a twelfth embodiment of the present invention will be described below with reference to FIG. 19. Incidentally, a configuration having functions identical with or similar to those of the portable computers 1 according to the first, fourth, and eleventh embodiments is denoted by the same reference symbol, and a description thereof is omitted. The twelfth embodiment differs from the eleventh embodiment in being provided with a signal line 71 provided on an outer surface 15b of a housing 11, and the fundamental configuration of the portable computer is identical with the eleventh embodiment.

As shown in FIG. 19, a plurality of conductive layers 73 and 74 are provided on an outer surface 15b of a housing 11. The one conductive layer 73 forms an antenna element 35 and a signal line 71 for supplying electricity to the antenna element 35. On the other hand, the other conductive layer 74 is a conductor layer 111 which functions purely as an antenna ground 36. A part of the conductive layer 73 covered with the conductor layer 111 becomes the signal line 71, and a part of the conductive layer 73 out of the conductor layer 111 becomes the antenna element 35.

A line width W of the signal line 71 is set in such a manner that the impedance between, for example, the conductor layer 111 and the signal line 71 matches with the input/output impedance of a wireless module 7 connected to an antenna 31.

According to the portable computer 1 configured as described above, it becomes possible to realize high antenna performance and high manufacturability as well as the eleventh embodiment. Further, when the signal line 71 is provided on the outer surface 15b of the housing 11, it is possible to provide the antenna element 35 even at a position to which a coaxial cable 41 cannot be drawn.

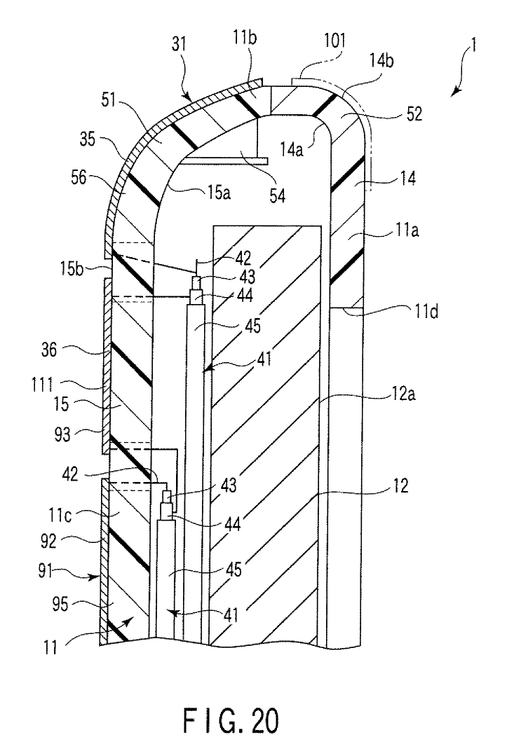

Next, a portable computer 1 as an electronic apparatus according to a thirteenth embodiment of the present invention will be described below with reference to FIG. 20. Incidentally, a configuration having functions identical with or similar to those of the portable computers 1 according to the first, eighth, and eleventh embodiments is denoted by the same reference symbol, and a description thereof is omitted. The thirteenth embodiment differs from the eleventh embodiment in being provided with another antenna 91, and the fundamental configuration of the portable computer is identical with the eleventh embodiment.

The portable computer 1 is provided with another antenna 91. This antenna 91 includes an antenna element 92, and an antenna ground 93. The antenna element 92 is provided on an outer surface 15b of a housing 11. Further, two antennas, i.e., an antenna 31 and the antenna 91 share one conductor layer 111 with each other as an antenna ground 36 or 93 of each of them.

According to the portable computer 1 configured as described above, it becomes possible to realize high antenna performance and manufacturability as well as the eleventh embodiment.

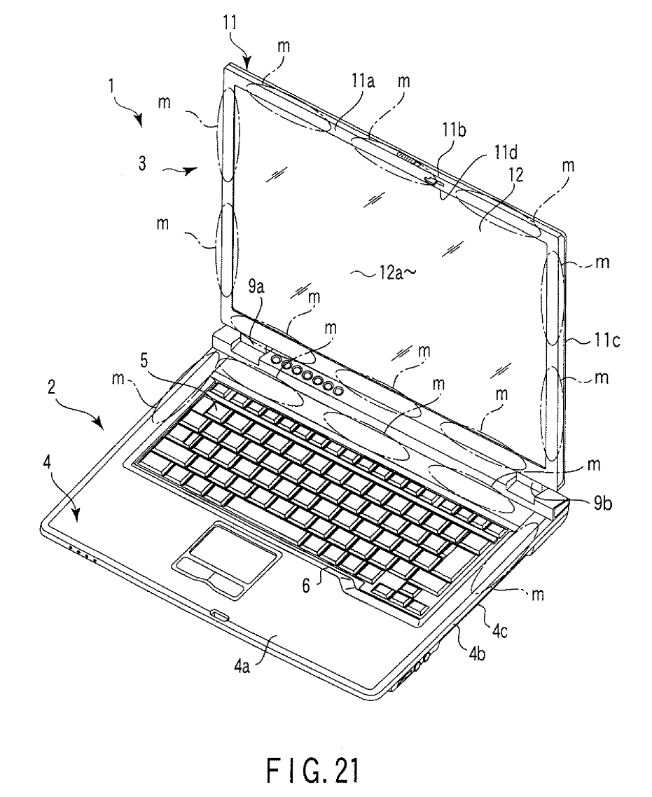

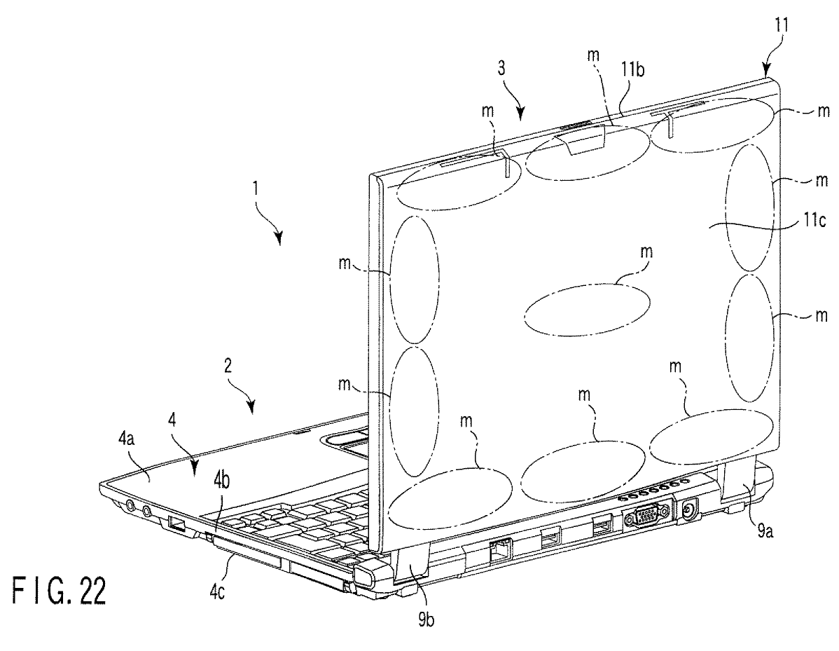

The portable computers 1 according to the first to thirteenth embodiments have been described above. However, the present invention is not limited to these. Constituent elements according to the embodiments may be appropriately combined with one another to be employed. The parts on which the antennas 31 and 91, and the passive element 101 can be mounted are not limited to the embodiments described above, and the antennas 31 and 91, and the passive element 101 can be mounted on various parts such as parts represented by regions indicated by the one dotted lines m in FIGS. 21 and 22. For example, as indicated by the two dotted line in each of FIGS. 18 to 20, the portable computers 1 according to the eleventh to thirteenth embodiments may each be provided with a passive element 101.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing;
an inner conductor member provided inside the housing;
a conductor part with which the housing is provided, and which restrains undesired electromagnetic radiation from leaking from inside the housing to the outside; and
an antenna including an antenna element that is provided on an outer surface of the housing, the antenna using the conductor part as an antenna ground, wherein
the housing includes a non-conductor part that is out of the conductor part at least at a part of a region in which the antenna element is provided, and
when the antenna is viewed from a direction in which the antenna element and the housing overlap each other, a size of a part of the antenna element overlapping the non-conductor part is larger than a part of the antenna element overlapping the conductor part.

2. The electronic apparatus according to claim 1, wherein
the entirety of the antenna element is provided on the non-conductor part.

3. The electronic apparatus according to claim 1, wherein
an end part of the housing includes a curved surface section in which the outer surface of the housing is curved, and
at least a part of the antenna element is provided on the curved surface section.

4. The electronic apparatus according to claim 3, wherein
the inner conductor member is provided in a region out of the curved surface section in the housing.

5. The electronic apparatus according to claim 4, wherein
the inner conductor member is a display device including a display screen,
the housing includes a mask member in which an opening that exposes the display screen to the outside of the housing is provided, and a cover member combined with the mask member, and
the conductor part and the antenna element are provided on the cover member.

6. The electronic apparatus according to claim 5, wherein
the curved surface section is provided with an inner structure protruding from an inner surface of the housing toward the inside of the housing, and
at least a part of the antenna element is provided in a region in which the inner structure is provided.

7. The electronic apparatus according to claim 1, further comprising a second antenna including another antenna element that is provided on the outer surface of the housing, wherein the said antenna and the said second antenna share the one conductor part with each other as the antenna ground of the said antenna and an antenna ground of the said second antenna.

8. The electronic apparatus according to claim 1, further comprising a signal line provided on the outer surface of the housing integral with the antenna element, wherein
the conductor part is a conductive layer provided in a region opposed to the signal line, and a line width of the signal line is set in such a manner that an impedance between the conductive layer and the signal line matches with an input/output impedance of a wireless module connected to the antenna.

9. An electronic apparatus comprising:
a housing;
an inner conductor member provided inside the housing; and
an antenna including an antenna element and an antenna ground, wherein
the antenna element is provided on an outer surface of the housing, and the antenna ground is provided on the outer surface of the housing on which the antenna element is provided.

10. The electronic apparatus according to claim 9, wherein
when the antenna is viewed from a direction in which the antenna element and the housing overlap each other, a size of a part of the antenna element overlapping the inner conductor member is smaller than a size of a part of the antenna ground overlapping the inner conductor member.
